(19) United States
(12) Patent Application Publication
(10) Pub. No.: US 2025/0149613 A1
(43) Pub. Date: May 8, 2025

(54) Unit Cell Manufacturing Device and Manufacturing Method

(71) Applicant: LG Energy Solution, Ltd., Seoul (KR)

(72) Inventors: Yun Ho Park, Daejeon (KR); Gyo Ryun No, Daejeon (KR)

(73) Assignee: LG Energy Solution, Ltd., Seoul (KR)

(21) Appl. No.: 18/683,044

(22) PCT Filed: Aug. 24, 2022
(86) PCT No.: PCT/KR2022/012654

§ 371 Date: Feb. 12, 2024

(30) Foreign Application Priority Data
Sep. 3, 2021 (KR) 10-2021-0117702

(51) Int. Cl. H01M 10/04; H01M 50/406

(52) U.S. Cl. CPC H01M 10/0404; H01M 50/406

(57) ABSTRACT

One embodiment of the present invention provides a unit cell manufacturing device comprising a vision part for measuring a measurement value comprising the position information of at least one of the central electrode, the upper separator, the lower separator, the upper electrode and the lower electrode in the unit cell; and a control part for calculating the position correction value of at least one of the central electrode, the upper separator, the lower separator, the upper electrode, and the lower electrode, based on the measurement value measured in the vision part, and correcting at least one of the position of the central electrode supplied to the laminate conveying part, the position of the upper electrode supplied to the laminate conveying part, the position of the lower electrode supplied to the laminate conveying part and the cutting position of the laminate cutting part, based on the calculated position correction value.

### TECHNICAL FIELD

The present application claims the benefit of priority based on Korean Patent Application No. 10-2021-0117702 filed on Sep. 3, 2021, the entire contents of which are incorporated herein by reference.

The present disclosure relates to a unit cell manufacturing device and a manufacturing method. More specifically, the present disclosure relates to a unit cell manufacturing device and a manufacturing method in which the position of at least one of a central electrode, an upper separator, a lower separator, an upper electrode, and a lower electrode is corrected.

### BACKGROUND ART

As technology development and demand for mobile devices is increased, rechargeable secondary batteries are widely used as energy sources for various mobile devices. In addition, the secondary battery is also attracting attention as an energy source for electric vehicles, hybrid vehicles, etc., which are proposed as a solution to air pollution caused by existing gasoline vehicles or diesel vehicles.

Secondary batteries are classified into coin-type batteries, cylindrical batteries, prismatic batteries, and pouch-type batteries depending on the shape of the battery case. In general, the electrode assembly built into the battery case is classified into a jelly-roll type obtained by interposing a separator between the positive electrode and the negative electrode and then winding them, a stack type obtained by stacking a plurality of unit cells with a separator interposed between the positive electrode and the negative electrode, and a stack/folding type obtained by winding unit cells with a separation film.

A unit cell of a stacked electrode assembly can be manufactured by cutting a laminate containing a central electrode, an upper separator disposed on the upper surface of the central electrode, a lower separator disposed on the lower surface of the central electrode, an upper electrode disposed on the upper separator, and a lower electrode placed on the lower separator. At this time, it is necessary to improve the alignment among the central electrode, the upper separator, the lower separator, the upper electrode and the lower electrode in the unit cell.

### PRIOR ART DOCUMENT

### Patent Document

### (Patent Document 1)

Korean Laid-open Patent Publication No. 10-2021-0058170

### DISCLOSURE

### Technical Problem

It is an object of the present disclosure to provide a unit cell manufacturing device and a manufacturing method capable of improving alignment of unit cells.

It is another object of the present disclosure to provide a unit cell manufacturing device and a manufacturing method capable of automatic correction.

### Technical Solution

In order to solve the above problems, the present invention can correct the position of at least one of the central electrode, the upper electrode, and the lower electrode and/or the cutting position of the laminate cutting part for cutting the upper separator and the lower separator as exemplary means.

For example, an embodiment of the present invention may provide a unit cell manufacturing device comprising a laminate conveying part for conveying a laminate containing an central electrode, an upper separator disposed on one surface of the central electrode, a lower separator disposed on the other surface of the central electrode, an upper electrode disposed on the upper separator and a lower electrode disposed on the lower separator; a central electrode conveying part for supplying the central electrode to the laminate conveying part; an upper electrode conveying part for supplying the upper electrode to the laminate conveying part; a lower electrode conveying part for supplying the lower electrode to the laminate conveying part; a laminate cutting part that forms a unit cell by cutting the upper separator and the lower separator of the laminate; a vision part for measuring a measurement value comprising the position information of at least one of the central electrode, the upper separator, the lower separator, the upper electrode, and the lower electrode in the unit cell; and a control part for calculating the position correction value of at least one of the central electrode, the upper separator, the lower separator, the upper electrode, and the lower electrode, based on the measurement value measured in the vision part, and correcting at least one of the position of the central electrode supplied to the laminate conveying part, the position of the upper electrode supplied to the laminate conveying part, the position of the lower electrode supplied to the laminate conveying part and the cutting position of the laminate cutting part, based on the calculated position correction value.

In addition, another embodiment of the present invention may provide a unit cell manufacturing method comprising a step of forming a laminate containing a central electrode, an upper separator disposed on one side of the central electrode, a lower separator disposed on the other surface of the central electrode, an upper electrode disposed on the upper separator and a lower electrode disposed on the lower separator; a step of forming a unit cell by cutting the upper separator and the lower separator of the laminate; a step of measuring a measurement value comprising the position information of at least one of the central electrode, the upper separator, the lower separator, the upper electrode and the lower electrode in the unit cell; a step of calculating the position correction value of at least one of the central electrode, the upper separator, the lower separator, the upper electrode, and the lower electrode, based on the measurement value; a step of correcting at least one of the position of the central electrode in the step of forming the laminate, the position of the upper electrode in the step of forming the laminate, the position of the lower electrode in the step of forming the laminate, and the cutting position of the laminate in the step of forming the unit cell, based on the calculated position correction value.

### Advantageous Effects

As an effect of the present disclosure, it is possible to provide a unit cell manufacturing device and a manufacturing method capable of improving alignment of unit cells.

As another effect of the present disclosure, it is possible to provide a unit cell manufacturing device and a manufacturing method capable of automatic correction.

### DESCRIPTION OF DRAWINGS

FIG. 1 is a schematic diagram of a unit cell manufacturing device according to an embodiment of the present invention.

FIG. 2 is a perspective view of a unit cell according to an embodiment of the present invention.

FIG. 3 is a perspective view of a unit cell according to another embodiment of the present invention.

FIG. 4 is a diagram for explaining a measurement value measured by a vision part in a unit cell according to an embodiment of the present invention.

FIG. 5 is a diagram for explaining a measurement value measured by a vision part in a unit cell according to another embodiment of the present invention.

FIG. 6 is a diagram for explaining a measurement value measured by a vision part in a unit cell according to another embodiment of the present invention.

FIG. 7 is a graph showing the improvement of the process capability index (Ppk) according to the present invention.

FIG. 8 is a graph showing a decrease in defect rate according to the present invention.

FIG. 9 is a graph showing the decrease in the number of manual corrections of the operator according to the present invention.

### BEST MODE

Hereinafter, embodiments of the present invention will be described in detail with reference to the accompanying drawings. In the drawings, all or part of each configuration may be exaggerated for convenience of description. In addition, it will be apparent to those skilled in the art that the present invention is not limited to the accompanying drawings or the content described in this specification, and the present invention may be implemented in various forms without departing from the technical spirit of the present invention.

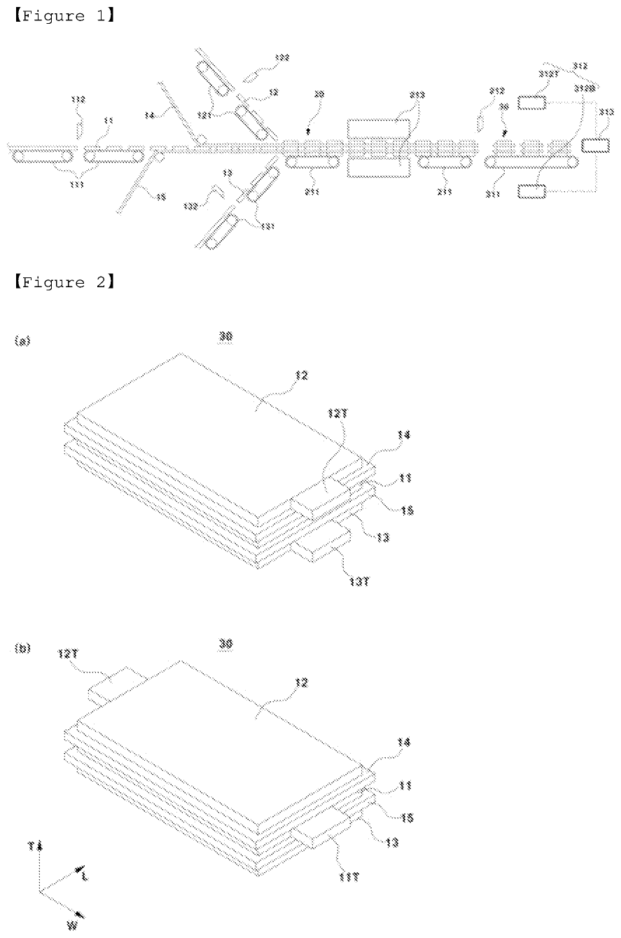

FIG. 1 is a schematic diagram of a unit cell manufacturing device according to an embodiment of the present invention.

In the present specification, each of the longitudinal direction L, the widthwise direction W and the thickness direction T is based on the conveying direction of the electrodes 11, 12, 13, the laminate 20 and the unit cell 30, respectively. Specifically, the conveying direction of each of the electrode 11, 12, 13, the laminate 20 and the unit cell 30 is referred to as a longitudinal direction L, the direction perpendicular to the longitudinal direction L on a plane is referred to as a widthwise direction W, and the direction perpendicular to the longitudinal direction L and the widthwise direction W is referred to as a thickness direction T. Unless otherwise described, the plane means a plane formed by the longitudinal direction L and the widthwise direction W. In addition, both side portions of any configuration refer to one side portion and the other side portion facing in the longitudinal direction L, and both end portions of any configuration refer to one end portion and the other end portion facing in the widthwise direction W.

Referring to the drawings, a unit cell manufacturing device according to an embodiment of the present invention may comprise a central electrode conveying part 111 for conveying the central electrode 11, a central electrode cutting part 112 for cutting the central electrode 11, an upper electrode conveying part 121 for conveying the upper electrode 12, an upper electrode cutting part 122 for cutting the upper electrode 12, a lower electrode conveying part 131 for conveying the lower electrode 13, a laminate conveying part 211 for conveying the laminate 20 comprising the cut central electrode 11, the cut upper electrode 12, the cut lower electrode 13, the upper separator 14 and the lower separator 15, a laminate cutting part 212 for cutting a laminate 20 to form a unit cell 30, a lamination part 213 for heating and pressing the laminate 20, a unit cell conveying part 311 for conveying the unit cell 30, a vision part 312 for measuring the unit cell 30 and a control part 313 for improving the alignment of the unit cell 30 based on the measurement value measured by the vision part 312.

The central electrode conveying part 111, the upper electrode conveying part 121 and the lower electrode conveying part 131 each may serve to transport the central electrode 11, the upper electrode 12 and the lower electrode 13, respectively. Specifically, each of the central electrode conveying part 111, the upper electrode conveying part 121 and the lower electrode conveying part 131 may convey each of the central electrode 11, the upper electrode 12 and the lower electrode 13 to supply them to the laminate conveying part 211. Each of the central electrode conveying part 111, the upper electrode conveying part 121 and the lower electrode conveying part 131 may be a conveyor belt, and may separate and convey the plurality of cut electrodes at regular intervals from each other after the electrodes are cut.

Each of the central electrode cutting part 112, the upper electrode cutting part 122 and the lower electrode cutting part 132 may serve to cut each of the central electrode 11, the upper electrode 12, and the lower electrode 13. To this end, each of the central electrode cutting part 112, the upper electrode cutting part 122 and the lower electrode cutting part 132 may comprise a cutting means such as a blade, a wheel, and a laser. For convenience of explanation, in the present specification, the electrode sheet and the individual electrodes formed by cutting the electrode sheet will be all referred to as electrodes (11, 12, and 13) without distinguishing the terms from each other.

The laminate 20 comprises a central electrode 11, an upper separator 14 disposed on one side of the central electrode 11, a lower separator 15 disposed on the other side of the central electrode 11, an upper electrode 12 disposed on the upper separator 14 and a lower electrode 13 disposed on the lower separator 15. That is, the laminate 20 has a structure in which the upper separator 14 and the upper electrode 12 are sequentially stacked on one side of the central electrode 11 and the lower separator 15 and the lower electrode 13 are sequentially stacked on the other side. In other words, the laminate 20 has a structure in which the lower electrode 13, the lower separator 15, the central electrode 11, the upper separator 14 and the upper electrode 12 are sequentially stacked from the lower side.

The laminate conveying part 211 may serve to convey the laminate 20. Specifically, the laminate conveying part 211 may convey the central electrode 11, the upper electrode 12 and the lower electrode 13 supplied from each of the central electrode conveying part 111, the upper electrode conveying part 121 and the lower electrode conveying parts 131 to be supplied to a subsequent unit such as the unit cell conveying part 311. The laminate conveying part 211 may also be a conveyor belt.

The laminate cutting part 212 cuts the laminate 20 to form a unit cell 30. To this end, the laminate cutting part 212 may also comprise a cutting means such as a blade, a wheel, and a laser.

The lamination part 213 may serve to fix the laminate 20 by heating and/or pressing. The lamination part 213 may include at least one of a lamination roller and a lamination heater, and the laminate 20 may be heated and/or pressed through a lamination roller and then heated through a lamination heater, but is not limited thereto.

The unit cell conveying part 311 may serve to convey the unit cell 30. The unit cell conveying part 311 may also be a conveyor belt, and may convey a plurality of unit cells 30 spaced apart from each other at regular intervals.

The vision part 312 measures the unit cell 30. Specifically, the vision part 312 may measure a measurement value including position information of at least one of the central electrode 11, the upper separator 14, the lower separator 15, the upper electrode 12 and the lower electrodes 13 of the unit cell 30. In other words, the measurement value of the unit cell 30 measured by the vision part 312 comprises position information of at least one of the central electrode 11, the upper separator 14, the lower separator 15, the upper electrode 12 and the lower electrode 13. Through this, it is possible to measure the alignment state between each component of the unit cell 30.

The vision part 312 may measure a measurement value of each of the plurality of unit cells 30. That is, the vision part 312 may measure a value including position information of at least one of the central electrode 11, the upper separator 14, the lower separator 15, the upper electrode 12 and the lower electrode 13 of each of the plurality of unit cells 30) which is a measurement value of each of the plurality of unit cells 30.

The vision part 312 comprises at least one of the upper vision part 312T disposed on the upper electrode 12 of the unit cell 30 and the lower vision part 312B disposed on the lower electrode 13 of the unit cell 30. Preferably, the vision part 313 comprises all of the upper vision part 312T disposed on the upper electrode 12 of the unit cell 30 and the lower vision part 312B disposed on the lower electrode 13 of the unit cell 30.

The upper vision part 312T measures the central electrode 11, the upper separator 14 and the upper electrode 12. In addition, the lower vision part 312B measures the central electrode 11, the lower separator 15 and the lower electrode 13. Specific measurement values measured by each of the upper vision part 312T and the lower vision part 312B will be described in detail in the description with respect to FIG. 4 to FIG. 6.

The control part 313 improves the alignment of the unit cell 30 based on the measurement value measured by the vision part 312. Specifically, the control part 313 may calculate the position correction value of at least one of the central electrode 11, the upper separator 14, the lower separator 15, the upper electrode 12 and the lower electrode 13, based on the measurement value measured in the vision part 312. Preferably, the control part 313 calculates the position correction value of each of the central electrode 11, the upper separator 14, the lower separator 15, the upper electrode 12 and the lower electrode 13, based on the measurement value measured in the vision part 312. In this case, the position correction value comprises at least one of a correction direction and a correction distance. Also, the control part 313 may correct at least one of the position of the central electrode 11 supplied to the laminate conveying part 211, the position of the upper electrode 12 supplied to the laminate conveying part 211, the position of the lower electrode 13 supplied to the laminate conveying part 211 and the cutting position of the laminate cutting part 212 based on the calculated position correction value. In this case, the control part 313 may automatically perform correction through the system, based on the calculated position correction value of at least one of the central electrode 11, the upper separator 14, the lower separator 15, the upper electrode 12 and the lower electrode 13, and in this regard, the control part 313 may comprise a programmable logic controller (PLC).

As described above, the vision part 312 may measure the measurement values of the plurality of unit cells 30, and in this case, the control part 313 may calculate the position correction value based on the average value of each measurement value of the plurality of unit cells 30. Through this, the control part 313 may calculate the position correction value based on a trend of misalignment of the plurality of unit cells 30.

In this case, it is possible to set at least one of the number of a plurality of unit cells 30 used in the calculation of the position correction value in the control part 313, the position correction value at which correction is started, the percentage of the actual position correction value to the position correction value, the first PLC transmission cycle and the second PLC transmission cycle to transmit the position correction value to the PLC, and the cycle to which the second PLC transmission cycle is applied. Here, the second PLC transmission cycle is a cycle which is applied immediately after the type of unit cell is replaced, and the first PLC transmission cycle is a cycle applied after being applied during the cycle to be applied the second PLC transmission cycle.

For example, if the number of the plurality of unit cells 30 used for the calculation of the position correction value is set to 20, the control part 313 may calculate the position correction value based on an average value of measurement values of 20 unit cells 30.

The position correction value at which correction is started is to prevent excessive correction. For example, if the position correction value at which correction is started is set to 1 mm, the position correction is performed only when the calculated position correction value is 1 mm or more. Accordingly, the calculated position correction value is less than 1 mm, the control part 313 does not perform the position correction.

The percentage of the actual position correction value to the position correction value is also to prevent excessive correction. For example, if the percentage of the actual position correction value to the position correction value is set to 70%, the actual position correction is performed by a value corresponding to 70% of the calculated position correction value.

The first PLC transmission cycle is to prevent system delay. The vision part 312 may continuously measure a measurement value of each of the plurality of unit cells 30, and the control part 313 may calculate the position correction value and perform the correction in real time, according to the measurement value of each of the plurality of unit cells 30 continuously measured, but this may not be preferable in terms of efficiency. Therefore, it is possible to set the first PLC transmission cycle and transmit the calculated position correction value to the PLC every set cycle and thus perform correction according to the position correction value transmitted to the PLC. At this time, the first PLC transmission cycle may be based on the number of the plurality of unit cells 30. For example, if the number of the first PLC transmission cycles is 30, the position correction value may be transmitted to the PLC based on 30 unit cells 30. If the number of the plurality of unit cells 30 used for the calculation of the position correction value is 20, and the number of the first PLC transmission cycle is 30, the control part 313 may first transmit the position correction value calculated based on the average value of the measurement values from the first unit cell 30 to the 20th unit cell 30 to the PLC, and may secondarily transmit the position correction value calculated based on the average value of the measurement values from the 31st unit cell 30 to the 50th unit cell 30 to the PLC. However, the first PLC transmission cycle may be set based on time. In addition, a similar effect may be obtained by setting the cycle to update the position correction value instead of the first PLC transmission cycle.

The second PLC transmission cycle is to increase the transmission frequency of the position correction value, which is the basis of the correction, by applying the PLC transmission cycle of the shortened position correction value immediately after the type of the unit cell 30 with a relatively high alignment defect rate of the unit cell 30 is replaced. In this regard, the second PLC transmission cycle that transmits the position correction value immediately after the type of unit cell 30 is replaced may be different from the first PLC transmission cycle described above, and specifically, may be shorter than the first PLC transmission cycle. However, depending on the design, the second PLC transmission cycle may be set equal to the first PLC transmission cycle or longer than the first PLC transmission cycle. The second PLC transmission cycle may also be based on the number of the plurality of unit cells 30, but may also be set based on time. In addition, a similar effect may be obtained by setting a cycle for updating the position correction value immediately after the type of unit cell 30 is replaced instead of the second PLC transmission cycle. In addition, a similar effect may be obtained by setting a cycle for updating the position correction value immediately after the type of unit cell 30 is replaced instead of the second PLC transmission cycle.

The cycle to which the second PLC transmission cycle is applied is the cycle to which the second PLC transmission cycle is applied immediately after the type of the unit cell 30 is replaced. Accordingly, the second PLC transmission cycle is applied during the cycle to which the second PLC transmission cycle is applied immediately after the type of the unit cell 30 is replaced, and the first PLC transmission cycle is applied after the cycle in which the second PLC transmission cycle is applied has elapsed immediately after the type of the unit cell 30 is replaced. The cycle to which the second PLC transmission cycle is applied may also be based on the number of the plurality of unit cells 30, but may also be set based on time.

In addition, when the control part 313 calculates the position correction value based on the average value of the measurement values of each of the plurality of unit cells 30, at least one of the measurement value outside the reference range among the measurement values of the n^{th} unit cell 30 and the measurement value having a difference equal to or greater than the reference value from the measurement value of the n-1^{th} unit cell 30 may be excluded from the measurement values that are the basis of the calculation. Depending on the measurement error of the vision part 312, an incorrect measurement value may be comprised in the measurement value, and when it is comprised in the measurement values that are the basis of calculation, there may be an error in the position correction value. Therefore, the control part 313 may exclude a measurement value outside the reference range among the measurement values of the n^{th} unit cell 30 from the measurement values that are the basis of calculation, and for example, may exclude a measurement value higher than the upper limit range and a measurement value lower than the lower limit range from the measurement values that are the basis of the calculation. In addition, the control part 313 may exclude a measurement value having a difference equal to or greater than the reference value from the measurement value of the n−1^{th} unit cell 30 from the measurement values that are the basis of the calculation, and for example, may exclude a measurement value that is larger or smaller than the measurement value of the n−1^{th} unit cell 30 by a reference value or more from measurement values that are the basis of calculation.

As described above, the control part 313 may calculate the position correction value of at least one of the central electrode 11, the upper separator 14, the lower separator 15, the upper electrode 12 and the lower electrode 13 based on the measurement value measured in the vision part 312. Also, the control part 313 may correct at least one of the position of the central electrode 11 supplied to the laminate conveying part 211, the position of the upper electrode 12 supplied to the laminate conveying part 211, the position of the lower electrode 13 supplied to the laminate conveying part 211 and the cutting position of the laminate cutting part 212 based on the calculated position correction value.

The control part 313 may correct the position of the central electrode 11 in the widthwise direction W. In addition, the control part 313 may correct the position of each of the upper electrode 12 and the lower electrode 13 in the longitudinal direction L and the widthwise direction W.

The control part 313 may correct the positions of the central electrode 11, the upper electrode 12 and the lower electrode 13 in the widthwise direction W by adjusting the position of the Edge Position Control (EPC) sensor measuring the position of each end portion of the central electrode 11, the upper electrode 12 and the lower electrode 13. Specifically, each of the central electrode conveying part 111, the upper electrode conveying part 121 and the lower electrode conveying part 131 may comprise an EPC roller for adjusting the position of the electrodes 11, 12, 13 in the widthwise direction W according to the Edge Position Control (EPC) sensor for measuring the position of at least one end portion of the electrodes 11, 12, 13 and the value measured by the EPC sensor, and the control part 313 may adjust the position of the EPC sensor comprised in each of the central electrode conveying part 111, the upper electrode conveying part 121, and the lower electrode conveying part 131. At this time, the EPC sensor is disposed before the electrodes 11, 12, 13 are cut into the cutting parts 112, 122, 132, and thus each of the central electrode 11, the upper electrode 12 and the lower electrode 13, which are corrected for their position in the widthwise direction W by the control part 313, is an electrode sheet before being cut into each of the central electrode cutting part 112, the upper electrode cutting part 122 and the lower electrode cutting part 132.

In addition, the control part 313 may correct each position of the upper electrode 12 and the lower electrode 13 in the longitudinal direction L by adjusting the speed of each of the upper electrode 12 and the lower electrode 13 supplied to the laminate conveying part 211. At this time, each of the upper electrode 12 and the lower electrode 13, which are corrected in position in the longitudinal direction L by the control part 313, is an individual electrode cut into each of the upper electrode cutting part 122 and the lower electrode cutting part 132.

The correction of the cutting position of the laminate cutting part 212 may be performed by automatic correction through the system in the control part 313 based on the position correction value calculated in the control part 313, and may also be performed by manual correction by directly inputting the cutting position of the laminate cutting part 212 corrected by the calculated position correction value to the control part 313 by the operator.

The control part 313 may have an alarm function. For example, the control part 313 determines a defect in the placement angle according to the rotation of the central electrode 11, a defect in placement angle according to the rotation of the upper electrode 12, a defect in placement angle according to the rotation of the lower electrode 13, a defect in the cutting of the central electrode 11, a defect in the cutting of the upper electrode 12, a defect in the cutting of the lower electrode 13, and a defect in the cutting angle of the separators 14 and 15, etc. which are defects that are difficult to perform automatic correction, and it may set an alarm to sound when these defects occur. Therefore, the operator can listen to the alarm and perform manual correction on items for which automatic correction is difficult. To this end, it goes without saying that the vision part 312 may further measure values necessary for determining a defect, as measurement values.

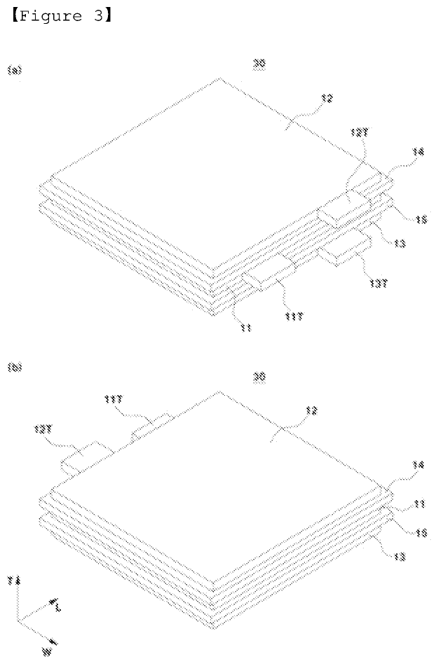

FIG. 2 is a perspective view of a unit cell according to an embodiment of the present invention.

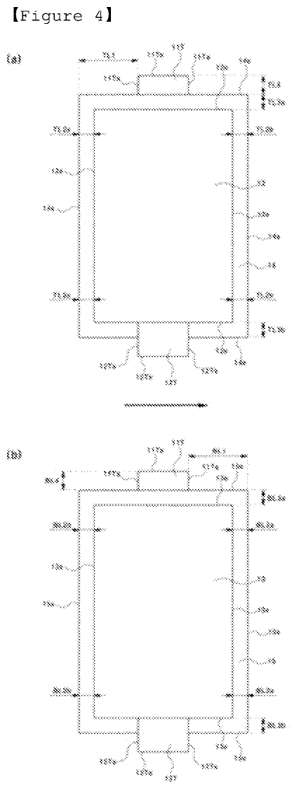

FIG. 3 is a perspective view of a unit cell according to another embodiment of the present invention.

Referring to FIG. 2 and FIG. 3, the unit cell 30 comprises a central electrode 11 having a tap 11T, an upper separator 14 disposed on the upper surface of the central electrode 11, an upper electrode 12 disposed on the upper surface of the upper separator 14 and having the tap 12T, a lower separator 15 disposed on the lower surface of the central electrode 11, and a lower electrode 13 disposed on the lower surface of the lower separator 15 and having the tap 13T. The taps 11T, 12T, 13T have shapes protruding from one end portion of the electrodes 11, 12, 13.

Each of the upper electrode 12 and the lower electrode 13 may be an electrode having a polarity different from that of the central electrode 11. For example, the central electrode 11 may be a negative electrode, and each of the upper electrode 12 and the lower electrode 13 may be a positive electrode. Alternatively, the central electrode 11 may be a positive electrode, and each of the upper electrode 12 and the lower electrode 13 may be a negative electrode.

Referring to FIG. 2, in the unit cell 30 according to an embodiment of the present invention, the tap 12T of the upper electrode 12 and the tap 13T of the lower electrode 13 are disposed in the opposite direction to the tap 11T of the central electrode 11. Each of the tap 11T of the central electrode 11, the tap 12T of the upper electrode 12, and the tap 13T of the lower electrode 13 may be disposed at the center of one end portion where the tab of the electrode is formed. In addition, when viewed in the widthwise direction W, the tap 12T of the upper electrode 12 and the tap 13T of the lower electrode 13 may be disposed to overlap with the tap 11T of the central electrode 11 in the thickness direction T.

Referring to FIG. 3, in the unit cell 30 according to another embodiment of the present invention, the tap 12T of the upper electrode 12 and the tap 13T of the lower electrode 13 are disposed spaced apart from each other in the same direction as the tap 11T of the central electrode 11. The tap 11T of the central electrode 11 is disposed to be biased toward one side portion of the unit cell 30, and each of the tap 12T of the upper electrode 12 and the tap 13T of the lower electrode 13 may be disposed to be biased toward the other side portion of the unit cell 30. In FIG. 3(a), the tap 11T of the central electrode 11 is disposed to be biased toward the left side portion of the unit cell 30, and each of the tap 12T of the upper electrode 12 and the tap 13T of the lower electrode 13 is shown as being biased toward the right side portion of the unit cell 30, but the tap 11T of the central electrode 11 is disposed to be biased toward the right side portion of the unit cell 30, and also each of the taps 12T of the upper electrode 12 and the taps 13T of the lower electrode 13 may be disposed to be biased toward the left side portion of the unit cell 30. The tap 12T of the upper electrode 12 and the tap 13T of the lower electrode 13 may be disposed to overlap each other on a plane.

FIG. 4 is a diagram for explaining the measurement value measured by the vision part in the unit cell of FIG. 2. FIG. 4(a) is a diagram for explaining measurement values of the upper vision part 312T, and FIG. 4(b) is a diagram for explaining measurement values of the lower vision part 312T.

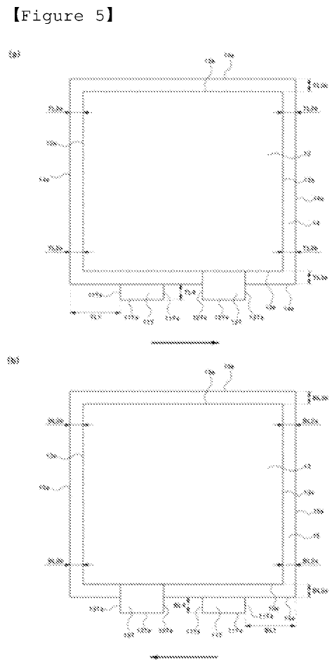

FIG. 5 is a diagram for explaining the measurement value measured by the vision part in the unit cell of FIG. 3. FIG. 5(a) is a diagram for explaining measurement values of the upper vision part 312T, and FIG. 5(b) is a diagram for explaining measurement values of the lower vision part 312T.

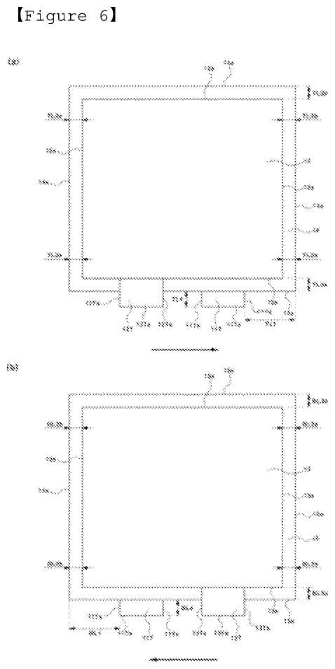

FIG. 6 is a diagram for explaining the measurement value measured by the vision part in a structure in which the unit cell of FIG. 3 is deformed. FIG. 6(a) is a diagram for explaining measurement values of the upper vision part 312T, and FIG. 6(b) is a diagram for explaining measurement values of the lower vision part 312T.

The upper vision part 312T measures at least one of a distance TL1 between one side portion 14s of the upper separator 14 and one side portion 11Ts of the tap 11T of the central electrode 11, distances TL2a, TL2b between both side portions 14s of the upper separator 14 and both side portions 12s of the upper electrode 12, distances TL3a, TL3b between both end portions 14e of the upper separator 14 and both end portions 12e of the upper electrode 12, and a distance TL4 between one end portion 14e of the upper separator 14 and the end portion 11Te of the tap 11T of the central electrode 11. As shown in the figure, the end portion 11Te of the tap 11T of the central electrode 11 refers to an edge region connecting both side portions 11Ts of the tap 11Ts of the central electrode 11. Preferably, the upper vision part 312T measures all of the aforementioned distances. Here, one end portion 14e of the upper separator 14 is an end portion close to the tap 11T of the central electrode 11 among both end portions 14e of the upper separator 14.

Similarly, the lower vision part 312B measures at least one of the distance BL1 between one side portion 15s of the lower separator 15 and one side portion 11Ts of the tap 11T of the central electrode 11, distances BL2a, BL2b between both side portions 15s of the lower separator 15 and both side portions 13s of the lower electrode 13, distances BL3a, BL3b between both end portions 15e of the lower separator 15 and both end portions 13e of the lower electrode 13 and the distance BL4 between one end portion 15e of the lower separator 15 and the end portion 11Te of the tap 11T of the central electrode 11. Preferably, the lower vision part 312B measures all of the aforementioned distances. Here, one end portion 15e of the lower separator 15 is an end portion close to the tap 11T of the central electrode 11 of both end portions 15e of the lower separator 15.

As shown in the figure, the upper vision part 312T may measure the distance TL2a between one side portion 14s of the upper separator 14 and one side portion 12s of the upper electrode 12 in two or more regions and also may measure the distance TL2b between the other side portion 14s of the upper separator 14 and the other side portion 12s of the upper electrode 12 in two or more regions. Similarly, the lower vision part 312B may measure the distance BL2a between one side portion 15s of the lower separator 15 and one side portion 13s of the lower electrode 13 in two or more regions, and also may measure the distance BL2b between the other side portion 15s of the lower separator 15 and the other side portion 13s of the lower electrode 13 in two or more regions. However, the upper vision part 312T may measure the distance TL2a between one side portion 14s of the upper separator 14 and one side portion 12s of the upper electrode 12 in one region, and also may measure the distance TL2b between the other side portion 14s of the upper separator 14 and the other side portion 12s of the upper electrode 12 in one region. Similarly, the lower vision part 312B may measure the distance BL2a between one side portion 15s of the lower separator 15 and one side portion 13s of the lower electrode 13 in one region and also may measure the distance BL2b between one side portion 15s of the lower separator 15 and one side portion 13s of the lower electrode 13 in one region.

Also, the upper vision part 312T may measure the distance TL3a between one end portion 14e of the upper separator 14 and one end portion 12e of the upper electrode 12 in two or more regions, and also may measure the distance TL3b between the other end portion 14e of the upper separator 14 and the other end portion 12e of the upper electrode 12 in two or more regions. Similarly, the lower vision part 312B may measure the distance BL3a between one end portion 15e of the lower separator 15 and one end portion 13e of the lower electrode 13 in two or more regions, and also may measure the distance BL3b between the other end portion 15e of the lower separator 15 and the other end portion 13e of the lower electrode 13 in two or more regions. However, as shown in the figure, the upper vision part 312T may measure the distance TL3a between one end portion 14e of the upper separator 14 and one end portion 12e of the upper electrode 12 in one region, and also may measure the distance TL3b between the other end portion 14e of the upper separator 14 and the other end portion 12e of the upper electrode 12 in one region. Similarly, the lower vision part 312B may measure the distance BL3a between one end portion 15e of the lower separator 15 and one end portion 13e of the lower electrode 13 in one region, and also may measure the distance BL3b between the other end portion 15e of the lower separator 15 and the other end portion 13e of the lower electrode 13 in one region.

If the distance TL1 between one side portion 14s of the upper separator 14 and one side portion 11Ts of the tap 11T of the central electrode 11 measured by the upper vision part 312T and the distance BL1 between one side portion 15s of the lower separator 15 and one side portion 11Ts of the tap 11T of the central electrode 11 measured by the lower vision part 312B is greater than the reference value, the control part 313 may correct the cutting position of the laminate cutting part 212 in a direction from one side portion of the tap 11T of the central electrode 11 toward the other side portion. If the distance TL1 between one side portion 14s of the upper separator 14 and one side portion 11Ts of the tap 11T of the central electrode 11 measured by the upper vision part 312T and the distance BL1 between one side portion 15s of the lower separator 15 and one side portion 11Ts of the tap 11T of the central electrode 11 measured by the lower vision part 312B is smaller than the reference value, the control part 313 may correct the cutting position of the laminate cutting part 212 in a direction from the other side portion of the tap 11T of the central electrode 11 toward one side portion. However, the cutting position of the laminate cutting part 212 may be performed by manual correction by directly inputting the cutting position of the laminate cutting part 212 corrected by the calculated position correction value to the control part 313 by the operator.

If the distance (TL2a, or TL2b) between one side portion 14s of the upper separator 14 and one side portion 12s of the upper electrode 12 measured by the upper vision part 312T is greater than the reference value and the distance (TL2b, or TL2a) between the other side portion 14s of the upper separator 14 and the other side portion 12s of the upper electrode 12 is smaller than the reference value, the control part 313 corrects the upper electrode 12 in a direction from the other side portion of the upper electrode 12 toward one side portion. Similarly, if the distance (BL2a, or BL2b) between one side portion 15s of the lower separator 15 and one side portion 13s of the lower electrode 13 measured by the lower vision part 312B is greater than the reference value, and the distance (BL2b, or BL2a) between the other side portion 15s of the lower separator 15 and the other side portion 13s of the lower electrode 13 is smaller than the reference value, it corrects the lower electrode 13 in the direction from the other side portion of the lower electrode 13 toward one side portion. Here, one side portion refers to the opposite side portion of the other side portion, and the other side portion refers to the opposite side portion of one side portion, and the position of each of one side portion and the other side portion is not determined to be specific position.

If the distance (TL3a, or TL3b) between one end portion 14e of the upper separator 14 and one end portion 12e of the upper electrode 12 measured by the upper vision part 312T is greater than the reference value, and the distance (TL3b, or TL3a) between the other end portion 14e of the upper separator 14 and the other end portion 12e of the upper electrode 12 is smaller than the reference value, the control part 313 corrects the upper electrode 12 in a direction from the other end portion of the upper electrode 12 toward one end portion. Similarly, if the distance (BL3a, or BL3b) between one end portion 15e of the lower separator 15 and one end portion 13e of the lower electrode 13 measured by the lower vision part 312B is greater than the reference value, and the distance (BL3b, or BL3a) between the other end portion 15e of the lower separator 15 and the other end portion 13e of the lower electrode 13 is smaller than the reference value, it corrects the lower electrode 15 in the direction from the other end portion toward one end portion. Here, one end portion refers to the opposite end portion of the other end portion, and the other end portion refers to the opposite end portion of one end portion, and the position of each of one end portion and the other end portion is not determined to be specific position.

If the distance TL4 between one end portion 14e of the upper separator 14 and the end portion 11Te of the tap 11T of the central electrode 11 measured by the upper vision part 312T is greater than the reference value, the control part 313 corrects the position of the central electrode 11 in a direction from one end portion of the upper separator 14 toward the other end portion. If the distance TL4 between one end portion 14e of the upper separator 14 and the end portion 11Te of the tap 11T of the central electrode 11 measured by the upper vision part 312T is smaller than the reference value, it corrects the position of the central electrode 11 in the direction from the other end portion of the upper separator 14 toward one end portion. Similarly, if the distance BL4 between one end portion 15e of the lower separator 15 and the end portion 11Te of the tap 11T of the central electrode 11 measured by the lower vision part 312B is greater than the reference value, it corrects the position of the central electrode 11 in the direction from one end portion of the lower separator 15 toward the other end portion. If the distance BL4 between one end portion 15e of the lower separator 15 and the end portion 11Te of the tap 11T of the central electrode 11 measured by the lower vision part 312B is smaller than the reference value, it corrects the position of the central electrode 11 from the other end portion of the lower separator 15 toward one end portion.

Hereinafter, for each case of FIGS. 4 to 6, the positions of one side portion 14s of the upper separator 14 and one side portion 11Ts of the tap 11T of the central electrode 11 measured by the upper vision part 312T and one side portion 15s of the lower separator 15 and one side portion 11Ts of the tap 11T of the central electrode 11 measured by the lower vision part 312B will be described. The conveying direction of the unit cell 30 is indicated by an arrow in the drawing.

In FIG. 4, one side portions (11Ts, 14s, and 15s) of each of the tap 11T of the central electrode 11, the upper separator 14 and the lower separator 15 may be side portions disposed in a direction opposite to the conveying direction of the unit cell 30. one side portion of each of the tap 11T and the upper separator 14 of the central electrode 11 based on FIG. 4(a) is a side portion disposed on the left side, and one side portion of each of the tap 11T of the central electrode 11 and the lower separator 15 based on FIG. 4(b) is a side portion disposed on the right side. Accordingly, based on FIG. 4(a), the upper vision part 312T may measure a distance TL1 between the left side portion 14s of the upper separator 14 and the left side portion 11Ts of the tap 11T of the central electrode 11, and based on FIG. 4(b), the lower vision part 312B can measure the distance BL1 between the right side portion 15s of the lower separator 15 and the right side portion 11Ts of the tap 11T of the central electrode 11.

However, depending on the design, one side portions (11Ts, 14s, 15s) of each of the tap 11T of the central electrode 11, the upper separator 14 and the lower separator 15 may be side portions disposed in the conveying direction of the unit cell 30. Accordingly, based on FIG. 4(a), the upper vision part 312T may measure the distance between the right side portion 14s of the upper separator 14 and the right side portion 11Ts of the tap 11T of the central electrode 11, and based on FIG. 4(b), the lower vision part 312B may measure the distance between the left side portion 15s of the lower separator 15 and the left side portion 11Ts of the tap 11T of the central electrode 11. Also, the upper vision part 312T may measure the distance between both side portions 14s of the upper separator 14 and both side portions 11Ts of the tap 11T of the central electrode 11, and the lower vision part 312B may also measure the distance between both side portions 15s of the lower separator 15 and both side portions 11Ts of the tap 11T of the central electrode 11.

In FIG. 5, one side portions 14s, 15s of each of upper separator 14 and lower separator 15 may be side portions close to the tap 11T of the central electrode 11 among both side portions 14s, 15s of each of the upper separator 14 and the lower separator 15. one side portion 11Ts of the tap 11T of the central electrode 11 may be a side portion close to one side portions 14s, 15s of each of the upper separator 14 and the lower separator 15 among both side portions 11Ts of the tap 11T of the central electrode 11. Based on FIG. 5(a), one side portion of each of the tap 11T of the central electrode 11 and the upper separator 14 is a side portion disposed on the left side, and based on FIG. 5(b), one side portion of each of the tap 11T of the central electrode 11 and the lower separator 15 is a side portion disposed on the right side. Therefore, based on FIG. 5(a), the upper vision part 312T may measure the distance TL1 between the left side portion 14s of the upper separator 14 and the left side portion 11Ts of the tap 11T of the central electrode 11, and based on FIG. 5(b), the lower vision part 312B may measure the distance BL1 between the right side portion 15s of the lower separator 15 and the right side portion 11Ts of the tap 11T of the central electrode 11. Through this, it is possible to measure the distance between components to be measured without interference from other components.

Even in FIG. 6, one side portions 14s, 15s of each of the upper separator 14 and the lower separator 15 may be side portions close to the tap 11T of the central electrode 11 among both side portions 14s, 15s of each of the upper separator 14 and the lower separator 15. one side portion 11Ts of the tap 11T of the central electrode 11 may be a side portion close to one side portion of each of the upper separator 14 and the lower separator 15 among both side portions 11Ts of the tap 11T of the central electrode 11. Based on FIG. 6(a), one side portion of each of the tap 11T and the upper separator 14 of the central electrode 11 is a side portion disposed on the right side, and based on FIG. 6(b), one side portion of each of the tap 11T and the lower separator 15 of the central electrode 11 is a side portion disposed on the left side. Accordingly, based on FIG. 6(a), the upper vision part 312T may measure the distance TL1 between the right side portion 14s of the upper separator 14 and the right side portion 11Ts of the tap 11T of the central electrode 11, and based on FIG. 6(b), the lower vision part 312B may measure the distance BL1 between the left side portion 15s of the lower separator 15 and the left side portion 11Ts of the tap 11T of the central electrode 11. Through this, it is possible to measure the distance between components to be measured without interference from other components.

The unit cell manufacturing method according to an embodiment of the present invention comprises a step of forming a laminate comprising a central electrode, an upper separator disposed on one side of the central electrode, a lower separator disposed on the other surface of the central electrode, an upper electrode disposed on the upper separator and a lower electrode disposed on the lower separator; a step of forming a unit cell by cutting the upper separator and the lower separator of the laminate; a step of measuring a measurement value comprising the position information of at least one of the central electrode, the upper separator, the lower separator, the upper electrode and the lower electrode in the unit cell; a step of calculating the position correction value of at least one of the central electrode, the upper separator, the lower separator, the upper electrode, and the lower electrode, based on the measurement value; and a step of correcting at least one of the position of the central electrode in the step of forming the laminate, the position of the upper electrode in the step of forming the laminate, the position of the lower electrode in the step of forming the laminate, and the cutting position of the laminate in the step of forming the unit cell.

The description of the unit cell manufacturing device according to an embodiment of the present invention may be applied to the unit cell manufacturing method according to an embodiment of the present invention in substantially the same manner. For example, the step of measuring the measurement value measures the measurement value of each of a plurality of unit cells, and the step of calculating the position correction value may be a step of calculating the position correction value based on an average value of measurement values of each of a plurality of unit cells. Accordingly, a detailed description of the unit cell manufacturing method according to an embodiment of the present invention will be omitted.

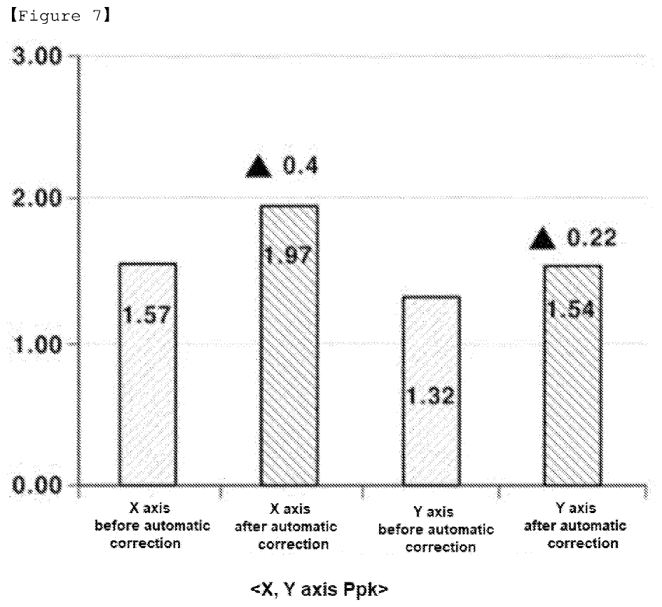

FIG. 7 is a graph showing the process capability index (Ppk) improvement according to the present invention.

The process capability index is the ratio of process capability to specification, and is an index indicating whether a process has sufficient capability to produce a product that meets specifications, and if the process capability index is high, it means that the accuracy of positioning at the center of the upper and lower specification limits is high. The process capability index indicating process capability is Cp, Cpk, Pp, Ppk, etc. and among them, Ppk using the overall standard deviation of the long-term process was measured.

Referring to the graph, it can be seen that when the X-axis automatic correction that is the longitudinal direction L correction was performed through the vision part 312 and the control part 313 of the present invention, the process capability index was increased by 0.4 from 1.57 to 1.97, as compared to the case of performing the manual correction by directly inputting the position correction value obtained by arbitrarily determining by the operator by looking at the alignment state of the unit cell 30, into the control part 313, and when the Y-axis automatic correction, which is the widthwise direction W correction, is performed, the process capability index increased by 0.22 from 1.32 to 1.54, as compared to the case where the manual correction was performed.

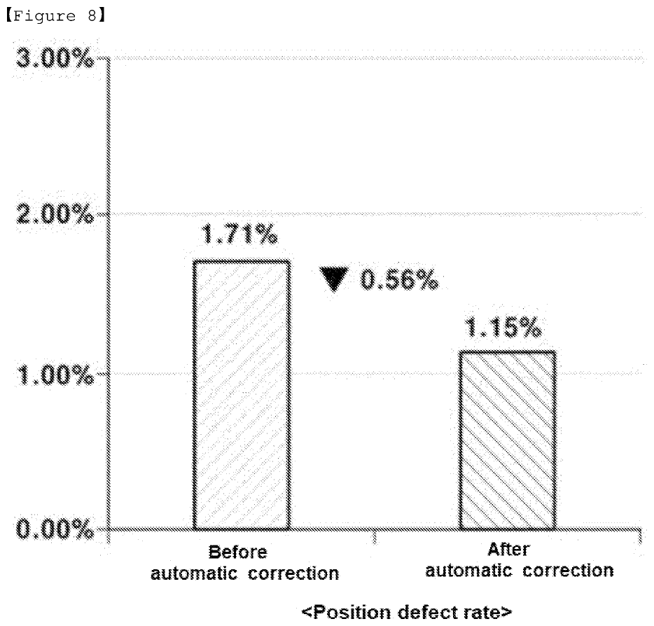

FIG. 8 is a graph showing a decrease in defect rate according to the present invention.

Referring to the graph, it can be seen that when the automatic correction was performed through the vision part 312 and the control part 313 of the present invention, the position defect rate was decreased by 0.56% from 1.71% to 1.15%, as compared to the case of performing the manual correction by directly inputting the position correction value obtained by arbitrarily determining by the operator by looking at the alignment state of the unit cell 30, into the control part 313.

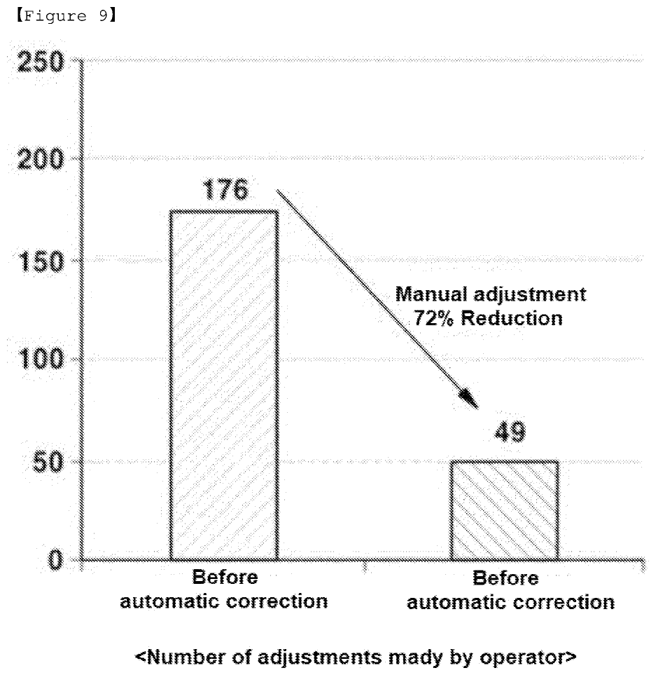

FIG. 9 is a graph showing a decrease in the number of manual corrections of an operator according to the present invention.

Referring to the graph, it can be seen that when automatic correction was performed through the vision part 312 and the control part 313 of the present invention, the number of manual corrections by the operator was reduced by about 72% from 176 times to 49 times during a cycle of one week, as compared to the case of performing the manual correction by directly inputting the position correction value obtained by arbitrarily determining by the operator by looking at the alignment state of the unit cell 30, into the control part 313.

In the case of the manual correction, the control part does not calculate the position correction value based on the position information of each of the plurality of unit cells, but rather the alignment status is identified based on the position information measured by the operator with the vision part of each of the plurality of unit cells or the position information directly checked with the operator's eyes, and thus the position correction value determined by the operator arbitrarily is directly input to the control part. Therefore, in the case of the manual correction, there is a limit that the inputted position correction value is not accurate, and also the position correction value, which is different depending on the operator, is derived and applied. On the other hand, as in the present invention, if the position correction value is calculated by the control part and automatic correction is performed accordingly, and thus it is possible to improve the calculation of the position correction value and the alignment of the unit cell, and it can reduce the effort of the operator.

In the above, an embodiment of the present invention has been described by way of example, but it is not intended to limit the embodiment of the present invention to the above-described embodiment. Those skilled in the art will be able to practice the present invention with appropriate modifications, for example, omit, change, or substitute all or part of the configuration of the present invention, or add other components with reference to the present specification and accompanying drawings, within the scope that does not depart from the technical spirit of the present invention.

In the present specification, terms such as one side portion, other side portion, one end portion, and other end portion are for distinguishing positions from each other, and do not mean absolute positions. one side portion referred to in one part of this specification may be referred to as the other side portion in another part of this specification. Similarly, one end portion referred to in one portion of this specification may be referred to as the other end portion in another portion of this specification.

In the present specification, the order numbers of the first, the second, etc. are for distinguishing the components from each other, and does not mean a priority order between components or an absolute order number. The first element in one part of this specification may be referred to as the second element in other parts of this specification.

The terms and expressions herein should be interpreted broadly and not in a limiting sense. The expression ‘comprising’ as used herein does not exclude the presence or addition of one or more other components other than the stated components. In this specification, expressions in the singular include the plural, unless the context explicitly excludes otherwise. In addition, each of the embodiments can be combined with each other, and unless contradicted, the content described in a specific embodiment may also be applied to other embodiments.

### DESCRIPTION OF SYMBOL

11: Central electrode
12: Upper electrode
13: Lower electrode
14: Upper separator
15: Lower separator
111: Central electrode conveying part
112: Central electrode cutting part
121: Upper electrode conveying part
122: Upper electrode cutting part
131: Lower electrode conveying part
132: Lower electrode cutting part
20: Laminate
211: Laminate conveying part
212: Laminate cutting part
213: Lamination part
311: Init cell conveying part
312: Vision part
313: Control part

1. A unit cell manufacturing device, comprising:
a laminate conveying part for conveying a laminate comprising a central electrode, an upper separator disposed on a first surface of the central electrode, a lower separator disposed on a second surface of the central electrode, an upper electrode disposed on the upper separator and a lower electrode disposed on the lower separator;
a central electrode conveying part for supplying the central electrode to the laminate conveying part;
an upper electrode conveying part for supplying the upper electrode to the laminate conveying part;
a lower electrode conveying part for supplying the lower electrode to the laminate conveying part;
a laminate cutting part that is configured to form a unit cell by cutting the upper separator and the lower separator of the laminate;
a vision part for measuring a measurement value comprising position information of at least one of the central electrode, the upper separator, the lower separator, the upper electrode, or the lower electrode of the unit cell; and
a control part for calculating a position correction value of the at least one of the central electrode, the upper separator, the lower separator, the upper electrode, or the lower electrode, based on the measurement value, and for correcting at least one of a position of the central electrode supplied to the laminate conveying part, a position of the upper electrode supplied to the laminate conveying part, a position of the lower electrode supplied to the laminate conveying part, or a cutting position of the laminate cutting part, based on the position correction value.

2. The unit cell manufacturing device according to claim 1, wherein the vision part comprises at least one of an upper vision part disposed adjacent to the upper electrode of the unit cell and a lower vision part disposed adjacent to the lower electrode of the unit cell,
the upper vision part is configured to measure at least one of a distance between a first side portion of the upper separator and a first side portion of a tab of the central electrode, a distance between the first side portion and a second side portion of the upper separator and first and second side portions of the upper electrode, respectively, a distance between first and second end portions of the upper separator and first and second end portions of the upper electrode, or a distance between one of the end portions of the upper separator and an end portion of the tab of the central electrode,
the lower vision part is configured to measure at least one of a distance between a first side portion of the lower separator and a first side portion of the tab of the central electrode, a distance between the first side portion and a second side portion of the lower separator and first and second side portions of the lower electrode, respectively, a distance between first and second end portions of the lower separator and first and second end portions of the lower electrode, or a distance between one of the end portions of the lower separator and the end portion of the tab of the central electrode, and
one of the end portions of each of the upper separator and the lower separator is closer to the tab of the central electrode than another one of the end portions of each of the upper separator and the lower separator.

3. The unit cell manufacturing device according to claim 2, wherein the tab of the upper electrode and the tab of the lower electrode are disposed in an opposite direction relative to the tab of the central electrode, and
one side portion of each of the tab of the central electrode, the upper separator and the lower separator is disposed in a direction opposite to a conveying direction of the unit cell relative to another one of the side portions of each of the tab of the central electrode, the upper separator and the lower separator.

4. The unit cell manufacturing device according to claim 2, wherein the tab of the upper electrode and the tab of the lower electrode are spaced apart from each other in a same direction as the tab of the central electrode,
one side portion of each of the upper separator and the lower separator is closer to the tab of the central electrode than another one of the side portions of each of the upper separator and the lower separator, and
one side portion of the tab of the central electrode is closer to one side portion of each of the upper separator and the lower separator than another one of the side portions of the tab of the central electrode.

5. The unit cell manufacturing device according to claim 1, wherein when a conveying direction of each of the central electrode, the upper electrode and the lower electrode is a longitudinal direction, and a direction perpendicular to the longitudinal direction on a plane is a widthwise direction, the control part is configured to correct the position of the central electrode in the widthwise direction and is configured to correct the position of each of the upper electrode and the lower electrode in the longitudinal direction and the widthwise direction.

6. The unit cell manufacturing device according to claim 5, wherein the control part is configured to correct the position of each of the upper electrode and the lower electrode in the longitudinal direction by adjusting the speed of each of the upper electrode and the lower electrode supplied to the laminate conveying part.

7. The unit cell manufacturing device according to claim 5, wherein the control part is configured to correct the position of each of the central electrode, the upper electrode and the lower electrode in the widthwise direction by adjusting the position of the Edge Position Control (EPC) sensor measuring the position of at least one of both end portions of each of the central electrode, the upper electrode and the lower electrode.

8. The unit cell manufacturing device according to claim 2, wherein the control part is configured such that if the distance between one side portion of the upper separator and one side portion of the tab of the central electrode measured by the upper vision part and the distance between one side portion of the lower separator measured by the lower vision part and one side portion of the tab of the central electrode is greater than the reference value, the control part corrects the cutting position of the laminate cutting part in a direction from one side portion of the tab of the central electrode toward the other side portion, and the control part is configured such that if the distance between one side portion of the upper separator and one side portion of the tab of the central electrode measured by the upper vision part and the distance between one side portion of the lower separator measured by the lower vision part and one side portion of the tab of the central electrode is smaller than the reference value, the control part corrects the cutting position of the laminate cutting part in a direction from the other side portion of the tab of the central electrode toward one side portion.

9. The unit cell manufacturing device according to claim 2, wherein the control part is configured such that if the distance between one side portion of the upper separator and one side portion of the upper electrode measured by the upper vision part is greater than a reference value and the distance between the other side portion of the upper separator and the other side portion of the upper electrode is smaller than the reference value, the control part corrects the upper electrode in a direction from the other side portion of the upper electrode toward one side portion,
the control part is configured such that if the distance between one side portion of the lower separator and one side portion of the lower electrode measured by the lower vision part is greater than the reference value and the distance between the other side portion of the lower separator and the other side portion of the lower electrode is smaller than the reference value, the control part corrects the lower electrode in a direction from the other side portion toward one side portion,
the control part is configured such that if the distance between one end portion of the upper separator and one end portion of the upper electrode measured by the upper vision part is greater than the reference value and the distance between the other end portion of the upper separator and the other end portion of the upper electrode is smaller than the reference value, the control part corrects the upper electrode in a direction from the other end portion of the upper electrode toward one end portion, and
the control part is configured such that if the distance between one end portion of the lower separator and one end portion of the lower electrode measured by the lower vision part is greater than the reference value and the distance between the other end portion of the lower separator and the other end portion of the lower electrode is smaller than the reference value, the control part corrects the lower electrode in a direction from the other end portion of the lower electrode toward one end portion.

10. The unit cell manufacturing device according to claim 2, wherein the control part is configured such that if the distance between one end portion of the upper separator and the end portion of the tab of the central electrode measured by the upper vision part is greater than the reference value, the control part corrects the position of the central electrode in a direction from one end portion of the upper separator toward the other end portion, and the control part is configured such that if the distance between one end portion of the upper separator and the end portion of the tab of the central electrode measured by the upper vision part is smaller than the reference value, the control part corrects the position of the central electrode in a direction from the other end portion of the upper separator toward one end portion, and
the control part is configured such that if the distance between one end portion of the lower separator and the end portion of the tab of the central electrode measured by the lower vision part is greater than the reference value, the control part corrects the position of the central electrode in a direction from one end portion of the lower separator toward the other end portion, and the control part is configured such that if the distance between one end portion of the lower separator and the end portion of the tab of the central electrode measured by the lower vision part is smaller than the reference value, the control part corrects the position of the central electrode in a direction from the other end portion of the lower separator toward one end portion.

11. The unit cell manufacturing device according to claim 1, wherein the vision part is configured to measure the measurement value of each of a plurality of unit cells, and the control part is configured to calculate the position correction value based on the average value of the measurement values of each of a plurality of unit cells.

12. The unit cell manufacturing device according to claim 11, wherein the control part is configured to set at least one of the number of a plurality of unit cells used in the calculation of the position correction value, the position correction value at which correction is started, the percentage of the actual position correction value to the position correction value, the first Programmable Logic Controller (PLC) transmission cycle and the second PLC transmission cycle to transmit the position correction value to the PLC, and the cycle to which the second PLC transmission cycle is applied,
the second PLC transmission cycle is a cycle which is applied immediately after the type of the unit cell is replaced, and
the first PLC transmission cycle is a cycle which is applied after the second PLC transmission cycle is applied during a cycle to apply the second PLC transmission cycle.

13. The unit cell manufacturing device according to claim 11, wherein the control part is configured such that when calculating the position correction value, the control part excludes at least one of a measurement value outside the reference range among the measurement values of the n^{th} unit cell and a measurement value having a difference equal to or greater than the reference value from the measurement value of the n−1^{th} unit cell, from the measurement values that are the basis of the calculation.

14. A unit cell manufacturing method, comprising:
forming a laminate containing a central electrode, an upper separator disposed on a first surface of the central electrode, a lower separator disposed on a second surface of the central electrode, an upper electrode disposed on the upper separator and a lower electrode disposed on the lower separator;
forming a unit cell by cutting the upper separator and the lower separator of the laminate;
measuring a measurement value comprising the position information of at least one of the central electrode, the upper separator, the lower separator, the upper electrode, or the lower electrode of the unit cell;
calculating a position correction value of the at least one of the central electrode, the upper separator, the lower separator, the upper electrode, or the lower electrode, based on the measurement value; and
correcting at least one of the position of the central electrode in the step of forming the laminate, the position of the upper electrode in the step of forming the laminate, the position of the lower electrode in the step of forming the laminate, or the cutting position of the laminate in the step of forming the unit cell, based on the position correction value.

15. The unit cell manufacturing method according to claim 14, wherein the measuring of the measurement value includes measuring the measurement value of each of a plurality of unit cells, and
the calculating of the position correction value is based on the average value of the measurement values of each of the plurality of unit cells.
